(19) United States
(12) Patent Application Publication
(10) Pub. No.: US 2009/0319160 A1
(43) Pub. Date: Dec. 24, 2009

(54) ACTIVE EXHAUST VALVE CONTROL STRATEGY FOR IMPROVED FUEL CONSUMPTION

(76) Inventors: Joseph E. Callahan, Greenwood, IN (US); Kwin Abram, Columbus, IN (US); Robin Willats, Columbus, IN (US); Ivan Arbuckle, Columbus, IN (US); James Egan, Indianapolis, IN (US)

Correspondence Address: PAMELA A. KACHUR, 950 W 450 S, BLDG. 4, COLUMBUS, IN, 47201, US

(21) Appl. No.: 12/195,759

(22) Filed: Aug. 21, 2008

Related U.S. Application Data
(60) Provisional application No. 61/075,044, filed on Jun. 24, 2008.

(51) Int. Cl. F02D 45/00; F01N 7/00

(52) U.S. Cl. 701/111; 60/324

(57) ABSTRACT

A control system for an exhaust valve and a method of actively controlling an exhaust valve includes monitoring at least a first engine characteristic, a second engine characteristic, and at least one additional noise determining characteristic. An exhaust valve position is then adjusted based on the first engine characteristic, the second engine characteristic, and the at least one additional noise determining characteristic to improve fuel economy without adversely affecting noise levels.

### RELATED APPLICATION

This application claims priority to U.S. Provisional Application 61/075,044, which was filed on Jun. 24, 2008.

### TECHNICAL FIELD

This invention generally relates to an exhaust valve that is actively controlled to improve fuel consumption under specified conditions without adversely affecting noise levels.

### BACKGROUND OF THE INVENTION

Exhaust systems include exhaust valves that can be utilized in various exhaust components to regulate exhaust gas flow through the exhaust system. One common issue for all types of exhaust valves is the trade-off between performance and noise. Exhaust valves introduce a level of flow restriction when closed. Choosing a level of flow restriction is a trade-off because there is a need for a high restriction for the best acoustic benefit and a need for a lower flow restriction to provide a minimal impact on fuel consumption. Active control of the valves has been used in an attempt to provide the most effective vehicle performance without increasing noise to uncomfortable levels.

Existing control strategies have been based on either one or two dimensional considerations to control valve opening/closing movement. For example, one known one dimensional control strategy controls valve opening as a function of engine mass air flow. One known two dimensional control strategy controls valve opening as a function of engine speed and manifold pressure, i.e. engine load.

One common problem with current strategies is that there can be a penalty for fuel economy when the valve is held closed for noise purposes, if a valve with high flow restriction is being utilized. For example, to keep tail pipe noise levels as low as possible, the exhaust valve is typically held closed for as long as the vehicle can handle the lack of performance. However, holding the valve closed under these types of conditions can adversely affect fuel economy.

### SUMMARY OF THE INVENTION

A method of actively controlling an exhaust valve includes monitoring at least a first engine characteristic and a second engine characteristic, monitoring at least one additional noise determining characteristic, and adjusting an exhaust valve position based on the first engine characteristic, the second engine characteristic, and the at least one additional noise determining characteristic to achieve a desired noise level.

In one example, a control system includes an exhaust valve associated with an exhaust component, at least first and second engine sensors to respectively monitor the first and second engine characteristics, and a controller that monitors the at least one additional noise determining characteristic. The controller adjusts the position of the exhaust valve based on the first and second engine characteristics and the additional noise determining characteristic.

In one example, the controller compares the first and second engine characteristics and the additional noise determining characteristic to a desired noise condition. The controller moves the exhaust valve from a closed position toward an open position in order to satisfy the desired noise condition to allow for improved fuel economy and a slightly higher noise level. Otherwise, the controller maintains the exhaust valve in its present position or moves the exhaust valve to a more closed position to reduce exhaust noise levels.

In one example, the first engine characteristic comprises engine speed and the second engine characteristic comprises engine load.

In one example, the at least one additional noise determining characteristic comprises at least one vehicle characteristic and/or at least one external environment characteristic.

The exhaust valve control system and method of controlling the exhaust valve provide an actively adjusted system that optimizes fuel economy when possible without adversely effecting noise comfort levels. These and other features of the present invention can be best understood from the following specification and drawings, the following of which is a brief description.

### BRIEF DESCRIPTION OF THE DRAWINGS

FIG. 1 is a schematic view of one example of a control system for controlling exhaust valve position.

FIG. 2 is one example of a control map used for a valve control strategy.

FIG. 3 is one example of graphical input used to develop the control map of FIG. 2.

FIG. 4 is a schematic diagram of one example of a control system when utilized with a multi-valve exhaust system.

### DETAILED DESCRIPTION OF THE PREFERRED EMBODIMENT

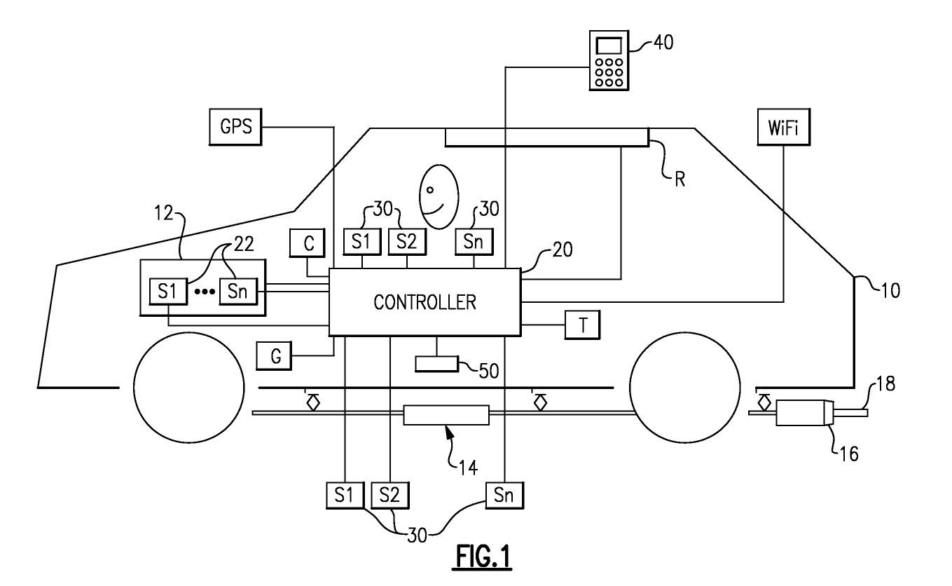

A vehicle 10 includes an engine 12 and an exhaust system 14 that includes at least one exhaust valve 16. In the example shown, the exhaust valve 16 is associated with a tail pipe 18; however, the exhaust valve 16 could be located anywhere within the exhaust system 14, and/or multiple exhaust valves could be included within the exhaust system 14. The exhaust system 14 is schematically shown in FIG. 1, and it should be understood that the exhaust system includes a plurality of different exhaust components as known.

The exhaust valve 16 is an electrically controlled valve that is actively controlled by a controller 20. The controller 20 controls movement of the exhaust valve 16 between open and closed positions to control exhaust gas flow through the exhaust system 14.

Multiple sensors 22 are used to monitor various engine characteristics. In one example, sensors 22 monitor at least one of engine speed (rpm), mass air flow, and manifold pressure, i.e. engine load. This data is communicated to the controller 20. The controller 20 analyzes the data and determines a current vehicle operating condition. This operating condition is compared to a desired noise condition and the controller 20 generates a control signal to control movement of the exhaust valve 16 to satisfy the noise condition.

Engine load can take the form of a signal indicating a number of operational cylinders in an engine and/or a signal representing intake or exhaust mass flow rate. For example, switching from a higher number of operational cylinders to a lower number of operational cylinders, such as switching from eight operating cylinders to four operating cylinders in a deactivation mode, could require the exhaust valve 16 to be moved to a more closed position to attenuate the additional low frequency noise generated in this mode. Using measured mass flow to influence the valve open position allows a nominally closed valve position to be adjusted according to mass flow, which better balances the need for valve closure for noise reduction against the need for reduced restriction to minimize pressure losses that could influence fuel economy.

For example, the exhaust valve 16 would typically be closed at an engine speed of 1500 rpm and a vehicle speed of 20 mph so that there would not be an excessive noise level at this relatively low vehicle speed. However, if vehicle speed were to increase to exceed a speed of 60 mph, for example, enough masking noise due to wind, etc., would exist within the vehicle, such that the exhaust valve 16 could be moved to a slightly more open position without adversely affecting vehicle interior noise levels. Thus, if a vehicle were to exceed a speed of 60 mph, the controller 20 could determine whether it was appropriate to generate a control signal to move the exhaust valve 16 from a closed position to a slightly open position, such as to a 5-15 degree opening angle for example. By doing this, fuel economy would be improved but noise levels would be perceived by an occupant to remain approximately the same as when the valve was in the closed position.

The controller 20 could also look at various other factors in order to determine whether conditions would be appropriate to move the exhaust valve 16 to a slightly open position to improve fuel economy. Additional sensors 30, which are either associated with the vehicle 10 or which are positioned external to the vehicle 10, monitor and transmit additional noise determining data to the controller 20. In the example discussed above, a vehicle speed sensor would communicate vehicle speed to the controller 20.

In another example, one of the sensors 30 is a microphone that monitors noise levels within a passenger compartment of the vehicle. If the level of noise in the compartment falls below a predetermined noise level indicating a reduced level of masking noise, the controller 20 will not allow the exhaust valve 16 to be opened for fuel economy purposes. Or, the controller 20 could operate in a feedback manner with the controller 20 issuing a control signal to move the valve 16 to a slightly open position, subsequently checking the noise level, moving the valve 16 to a more open position if the noise level in the passenger compartment is still acceptable, subsequently checking the noise level again, and continuing to repeat this process until the noise level exceeds an acceptable level. If the noise level is exceeded, the controller 16 can initiate a reverse process to move the valve 16 back to a position where the noise level was acceptable.

In another example, one of the sensors 30 is a coolant temperature sensor that monitors the temperature of coolant or other indication of engine or exhaust temperature such as an exhaust gas thermocouple. The controller 20 could increase restriction on cold engines to improve sound quality on cold exhaust. When temperatures reach a certain level this restriction could be removed by the controller 20.

In another example, the controller 20 monitors gear selection for a gear selector G to further control valve position. For example, when in a neutral gear the controller 20 could move the exhaust valve 16 to a more open control strategy to deliver a sportier sound characteristic, which could be undesirable during normal driving. This could be used in situation where a driver would want to demonstrate an aggressive sound profile for the vehicle by rapid throttle operation.

In another example, the controller 20 monitors cruise control C to further control valve position. For example, identifying that the cruise control is active would indicate a more comfort orientated driving style, which would correspond to a desire for a quieter setting. In this situation, the controller 20 would move the exhaust valve 16 to a more closed valve position for quiet cruising. Identifying that the cruise control is inactive, i.e. off, could indicate a more a performance orientated driving style that would be facilitated by a more open valve position providing reduced restriction and more engine power.

In another example, the controller 20 monitors traction control T to further control valve position. For example, the controller could simply use an indication that the traction control is “off,” or the controller 20 could utilize signals that identify the existence of tire slippage, suggesting loss of traction, to indicate a more aggressive driving style. This would indicate a preference for the exhaust valve 16 to be in a more open position for minimal restriction and high noise levels. Conversely, an absence of tire slippage and/or the traction control being “on” could indicate a more comfort style of driving with the exhaust valve 16 being provided in a more closed position for reduced noise levels.

In another example, the controller 20 monitors whether a convertible roof R is open or closed. For example, a signal indicating that the roof R is open could be used to instigate a reduction in exhaust noise by closing the exhaust valve 16 further, while an indication that the roof R is closed may allow for increased exhaust noise by moving the valve 16 to more open position or vice versa.

In another example, the controller 20 could further facilitate control based on the time of day. The exhaust valve 16 could be set to default to a quieter setting for operation at night, for example.

In another example, the controller 20 could further facilitate control of the exhaust valve 16 based on whether the vehicle 10 was being driven in a residential neighborhood. For example, WiFi or GPS detection could be used to identify when the vehicle 10 is operating in such residential areas.

In another example, Blue Tooth technology could be used to detect the presence of an active phone 40 to reduce exhaust noise levels as needed to hear clearly.

In another example, the vehicle 10 includes a selectable input 50 that can be actuated by a vehicle occupant. This input 50 would allow the occupant to select at least between a fuel economy mode and a noise level mode. Additionally, a pre-set strategy could be used, similar to that for seat/mirror controls for example, that would allow the occupant to set a desired configuration by simply pushing a button, for example. Also, such input selection/pre-set strategies could be developed given inputs by the occupant to assess exhaust noise levels/exhaust sounds that are favorable or unfavorable, and then a user preferred valve operating strategy could be developed via use of a neural network controller.

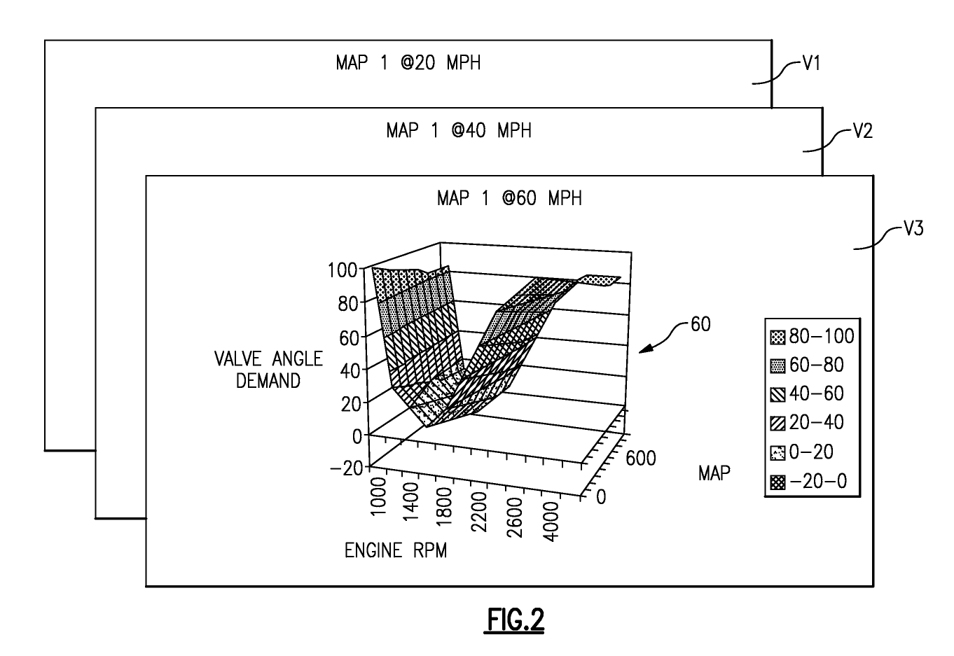

In one example, the controller 20 uses at least one multi-parameter map 60 (shown in FIG. 2) for determining valve control strategy. A plurality of maps 60 could also be used by the controller 20, which could then switch between different maps for different operating parameter conditions, e.g. different maps for a different number of operating cylinders.

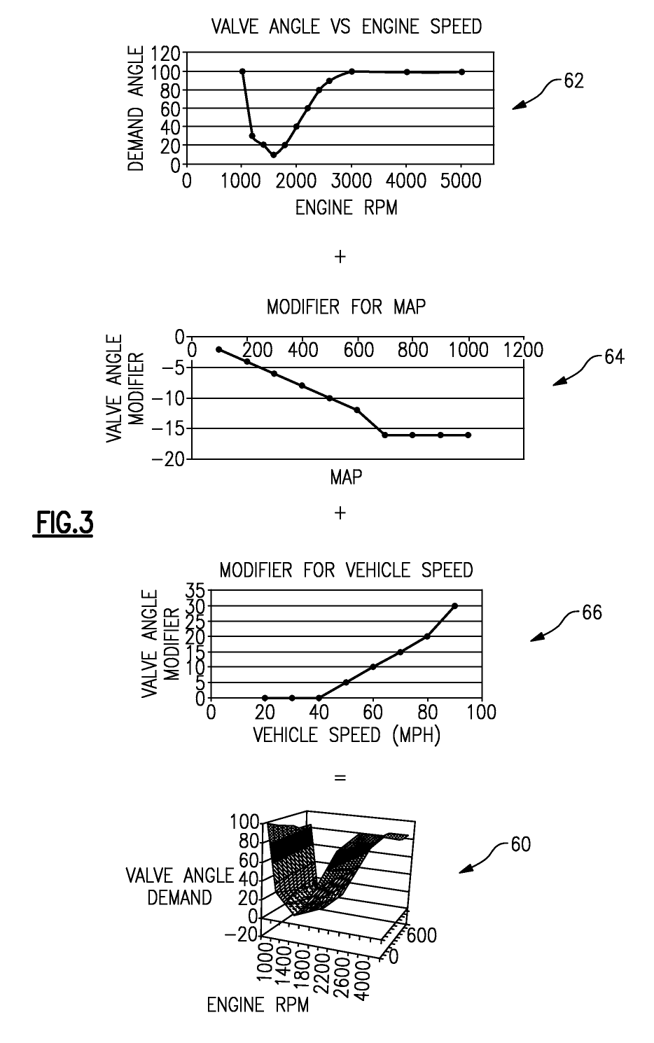

For example, a control map 60 can be used that relates required valve angle, as an output, to the values of several input parameters, such as engine speed and mass air flow. FIG. 3 shows one example of how an example control map 60 is developed. The control map 60 combines data from a first map 62 of valve angle vs. engine speed, a second map 64 that provides a valve angle modifier for mass air flow, and a third map 66 that provides a valve angle modifier for vehicle speed. The data from each of these control maps 62, 64, 66 is combined to provide a 3-dimensional output comprises the control map 60. This can be done with many different combinations of variables dependent upon vehicle application, driving conditions, etc.

As such, one control map can determine valve angle from three independent variables. Further, as shown in FIG. 2, this control map can be set for different vehicle speeds V1, V2, V3, etc. Further, different control maps can be developed for different engine temperatures and for a different number of operating engine cylinders. For example, a first control map can be developed could be used at low engine temperatures and a second control map could be developed for high engine temperatures. In one example, the first control map could be used for a high or low number of operating cylinders when used at a low engine temperature, with a second control map being used for a low number of operating cylinders at a high temperature, and a third control map being used for a high number of operating cylinders at a high temperature.

Further, one control map 60 can be developed to suit operation in a full cylinder operating mode, e.g. eight operating cylinders (V8), while a second control map 60 would be developed for operation of the exhaust valve 16 in a cylinder deactivated mode, e.g. four operating cylinders out of a total of eight cylinders (V8). The second control map is likely to have the exhaust valve 16 in a more closed position than the first control map for equivalent inputs of engine speed and mass air flow in order to attenuate the additional low frequency noise generated in the deactivated mode. The controller 20 determines which map to operate with depending on the state of the control signal which identified the number of operating cylinders. It should be understood that the disclosed control maps 60 are just some examples of control maps, and that many different control maps comprised from many different combinations of variables could be used by the system.

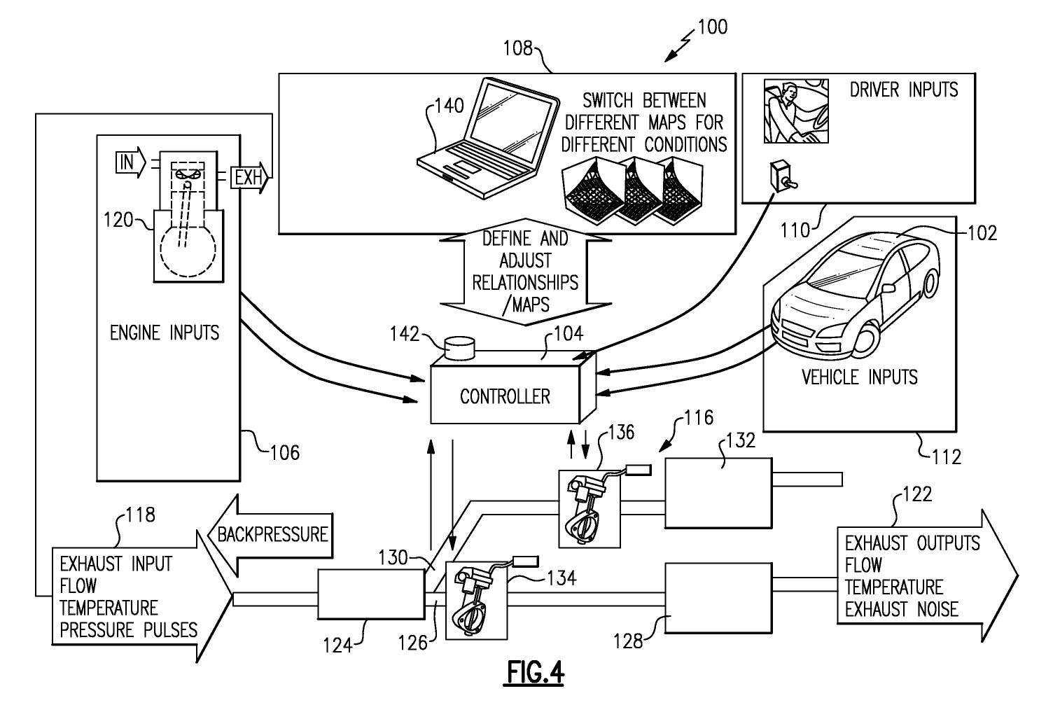

FIG. 4 shows another example control system 100 for controlling exhaust valve position. In this example, a vehicle 102 includes a controller 104 that receives engine input 106, developer input 108, driver input 110, and vehicle input 112. The vehicle 102 includes an exhaust system 116 having an input 118 that receives exhaust flow from an engine 120 and which includes at least one output 122. In the example shown, the exhaust system 116 includes a first exhaust component 124, such as a muffler for example, having a first output 126 extending to a second exhaust component 128 and a second output 130 extending to a third exhaust component 132. A first exhaust valve 134 is positioned downstream of the first output 126 and upstream of the second exhaust component 128, and a second exhaust valve 136 is positioned downstream of the second output 130 and upstream of the third exhaust component 132. Additional valves could also be included if needed.

The first 134 and second 136 exhaust valves are actively controlled valves that are controlled by the controller 104. In one example, a pulse width modulation signal is used to define the demanded valve position

In one example, the engine input 114 includes at least one of engine speed, number of operational cylinders, mass air flow, oil temperature, or any of the other engine characteristics discussed above. The driver input 110 comprises at least a selectable input to choose between a quiet or performance mode as discussed above. Vehicle inputs 112 include road speed, gear position, traction control, cruise control, etc. as described above. The developer inputs 108 comprise data used to directly control valve position as well as the control maps described above. PC interfaces 140 can be used to define and adjust relationships and maps as needed. The controller 104 independently controls the position of the first 134 and second 136 valves based on the control strategy described above. In one example, a manual valve position control 142 is associated with the controller 104 such that a user can manually set a desired valve position strategy.

In one example, the method of actively controlling the exhaust valve includes monitoring at least first and second engine characteristics, such as engine speed and engine load for example, monitoring at least one additional noise determining characteristic such as any of the examples given above for example, and then adjusting the exhaust valve position based on the first and second engine characteristics and any additional noise determining characteristics to improve fuel economy without adversely affecting noise levels.

The additional noise determining characteristics listed above are just some examples of characteristics that can be used by the controller to determine whether or not it is appropriate to provide valve opening to improve fuel economy. It should be understood that other noise determining characteristics could also be used. Further, the controller can utilize these characteristics in any number of combinations. For example, one additional characteristic could be utilized, all additional characteristics could be utilized, or various subset combinations of characteristics could be utilized by the controller.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A method of actively controlling an exhaust valve comprising the steps of:
a) monitoring at least a first engine characteristic and a second engine characteristic;
b) monitoring at least one additional noise determining characteristic; and
c) adjusting an exhaust valve position based on the first engine characteristic, the second engine characteristic, and the at least one additional noise determining characteristic to achieve a desired noise level.

2. The method according to claim 1 including comparing data from steps a) and b) to a desired noise condition and moving the exhaust valve from a closed position toward an open position in order to satisfy the desired noise condition.

3. The method according to claim 2 wherein the first engine characteristic comprises engine speed and the second engine characteristic comprises engine load.

4. The method according to claim 3 wherein the at least one additional noise determining characteristic comprises at least one vehicle characteristic.

5. The method according to claim 4 wherein the at least one vehicle characteristic comprises at least one of a vehicle speed, a vehicle interior noise level, engine coolant temperature, engine temperature, or exhaust temperature.

6. The method according to claim 4 wherein the at least one vehicle characteristic comprises at least one of a gear selection position, cruise control mode, traction control mode, or convertible roof position.

7. The method according to claim 3 wherein the at least one additional noise determining characteristic comprises at least one external environment characteristic.

8. The method according to claim 7 wherein the at least one external environment characteristic includes at least one of GPS detection of a residential area, time of day, or detection of an active phone.

9. The method according to claim 3 including determining engine load based on a signal indicating a number of operating engine cylinders.

10. The method according to claim 3 including determining engine load based on a signal representing intake or exhaust mass flow rate.

11. The method according to claim 2 wherein the desired noise condition is based on at least one of a vehicle speed limit, an acceptable passenger compartment noise level, time of day, or vehicle location.

12. The method according to claim 1 including providing a selectable input to be accessible by a vehicle occupant, and actuating the selectable input to specify at least one of a desired noise level and fuel economy mode.

13. The method according to claim 1 including developing at least one control map associated with a first vehicle operating mode and wherein step (c) includes providing a controller that accesses the at least one control map to determine a desired valve position for the first vehicle operating mode.

14. The method according to claim 13 wherein the at least one control map comprises at least first and second control maps associated with first and second vehicle operating modes and including switching between the first and second control maps to determine the desired valve position when switching between the first and second vehicle operating modes.

15. The method according to claim 14 wherein the first vehicle operating mode comprises a full engine operating mode and the second vehicle operating mode comprises a cylinder deactivation mode where at least one engine cylinder is non-operational.

16. The method according to claim 13 including developing the at least one control map to relate required valve angle as an output to a plurality of input parameters including engine speed and mass air flow.

17. A control system for actively controlling an exhaust valve comprising:
an exhaust valve associated with an exhaust component;
at least a first engine sensor and a second engine sensor, said first engine sensor to monitor a first engine characteristic and said second engine sensor to monitor a second engine characteristic; and
a controller that monitors at least one additional noise determining characteristic, said controller adjusting a position of said exhaust valve based on said first engine characteristic, said second engine characteristic, and said at least one additional noise determining characteristic to achieve a desired noise level.

18. The control system according to claim 17 including a selectable input to be accessible by a vehicle occupant, said selectable input including at least a first setting to specify a desired noise condition and a second setting to select a fuel economy mode.

19. The control system according to claim 17 wherein said controller analyzes said first engine characteristic, said second engine characteristic, and said at least one additional noise determining characteristic to determine a current vehicle condition, and wherein said controller compares said current vehicle condition to a desired noise condition and generates a control signal to move said exhaust valve from a closed position toward an open position in order to satisfy the desired noise condition.

20. The control system according to claim 19 wherein the first engine characteristic comprises engine speed and the second engine characteristic comprises engine load.

21. The control system according to claim 20 wherein the at least one additional noise determining characteristic comprises at least one vehicle characteristic.

22. The control system according to claim 20 wherein the at least one additional noise determining characteristic comprises at least one external environment characteristic.

23. The control system according to claim 20 including determining engine load based on at least one of a signal indicating a number of operating engine cylinders or a signal representing intake or exhaust mass flow rate.

24. The control system according to claim 19 wherein the desired noise condition is based on at least one of a vehicle speed limit, an acceptable passenger compartment noise level, time of day, or vehicle location.

25. The control system according to claim 17 including at least one control map associated with a first vehicle operating mode and wherein said controller generates a control signal to adjust a position of said exhaust valve based on said at least one control map when operating in said first vehicle operating mode.

26. The control system according to claim 25 wherein said at least one control map comprises at least first and second control maps associated with first and second vehicle operating modes and wherein said controller generates said control signal based on said first control map when operating in said first vehicle operating mode and generates said control signal based on said second control map when operating is said second vehicle operating mode.

27. The control system according to claim 26 wherein said first vehicle operating mode comprises a full engine operating mode and said second vehicle operating mode comprises a cylinder deactivation mode where at least one engine cylinder is non-operational.
